(19) United States
(12) Patent Application Publication
(10) Pub. No.: US 2007/0038492 A1
(43) Pub. Date: Feb. 15, 2007

(54) Model for process and workflows

(75) Inventors: Sean P. Ryan, Sammamish, WA (US); Jerald K. Noll, Kirkland, WA (US); Steven P. Anonsen, Fargo, ND (US); Timothy J. Brookins, West Fargo, ND (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/202,970

(22) Filed: Aug. 12, 2005

(51) Int. Cl. G05B 19/418

(52) U.S. Cl. 705/8

(57) ABSTRACT

A process is modeled in such a way that an interface to the process, or an abstract representation of the process, is separate from workflow implementations of the process. Process patterns can be captured, and customizations to a base process can be made as well.

### BACKGROUND

In some current business applications, the term “activity” is used to refer to logic or code that modifies or transforms data. In a business application, the activity may be business logic, but could effect a transformation or modification of data in a different way. For example, an activity might simply create informational data and place it in a location for a user to view (e.g., a simple notification).

Business process workflows are performed using a particular sequence or arrangement of activities. Some current business applications sequence activities without wait points, while some other applications stall the sequencing of activities while the system waits for a human response (such as an approval of an invoice, etc.).

Current business software applications that deal with process workflows suffer from disadvantages. Most are focused on transactions involving business data rather than on dynamic and ever-changing business-related processes. Business processes are either hard-coded within application business logic or bolted on after the fact using proprietary or off-the-shelf workflow technologies. In other words, process workflows are not automated very well in some current business applications.

One reason that automated process workflows have encountered difficulty is that there is currently no strong semantic link between data, activity, and process workflow. There have been some attempts to automate processes, and they have typically been made by workflow application vendors. Such vendors commonly build add-on applications that try to drive processes. These are frequently separate software packages from the application for which the process is to be automated, and hence they may not be integrated at all, with the application and its data. Some such workflow applications attempt to establish integration with the data of the application, but many do not and those that do require manual work by those installing the workflow application.

There are also a number of current document management systems. Such systems receive a document and flow it to different parties, and then store it. However, such document management systems have conventionally been highly customized solutions which cannot easily be generalized for use in other areas. While they manage documents and flow, the documents store semi-structured data, which typically have few internal rules for how they are structured (e.g. a document in a word processor) . And where such rules exist, they are not part of the process itself. In contrast, business applications typically have highly structured data and potentially many rules about how that data may change and how that data influences the flow of the process.

It can thus be seen that some processes have been automated in software. However, this was done in a rigid, technology implementation-specific way that is not easily adaptable to meet changing business needs or technology implementation requirements. With such approaches, business processes cannot be easily or cost-effectively modified or replaced and process automation has come at the cost of business and technology flexibility and agility.

The discussion above is merely provided for general background information and is not intended to be used as an aid in determining the scope of the claimed subject matter.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A process model abstracts a definition of a process from possible workflow implementations. One definition includes a contract specifying the interface to the process and a set of workflows that can be selected for activation. The contract specifies the data properties, activations, incomes, and outcomes for the process that each workflow must satisfy.

### BRIEF DESCRIPTION OF THE DRAWINGS

FIG. 1 is a block diagram of one computing environment in which some embodiments may be practiced.

FIG. 2 is a block diagram illustrating one example of a process model.

FIG. 3 shows a UML class diagram and a UML activity diagram illustrating one exemplary embodiment of a process model.

FIG. 4 illustrates a concrete example of a UML class diagram and UML activity diagram for a model of a process.

FIG. 5A shows a matadata structure representing the model shown in FIG. 2.

FIG. 5B illustrates an exemplary user interface display showing how a model can be generated.

FIG. 6 shows an activity diagram for another exemplary process.

FIGS. 6A and 6B illustrate exemplary user interfaces used in the process shown in FIG. 6.

FIG. 7 illustrates one example of a process pattern.

FIG. 8 illustrates one example of customizing a process.

### DETAILED DESCRIPTION

The present invention relates to a process model. However, before describing the present invention in greater detail, one illustrative environment in which the present invention can be used will be described.

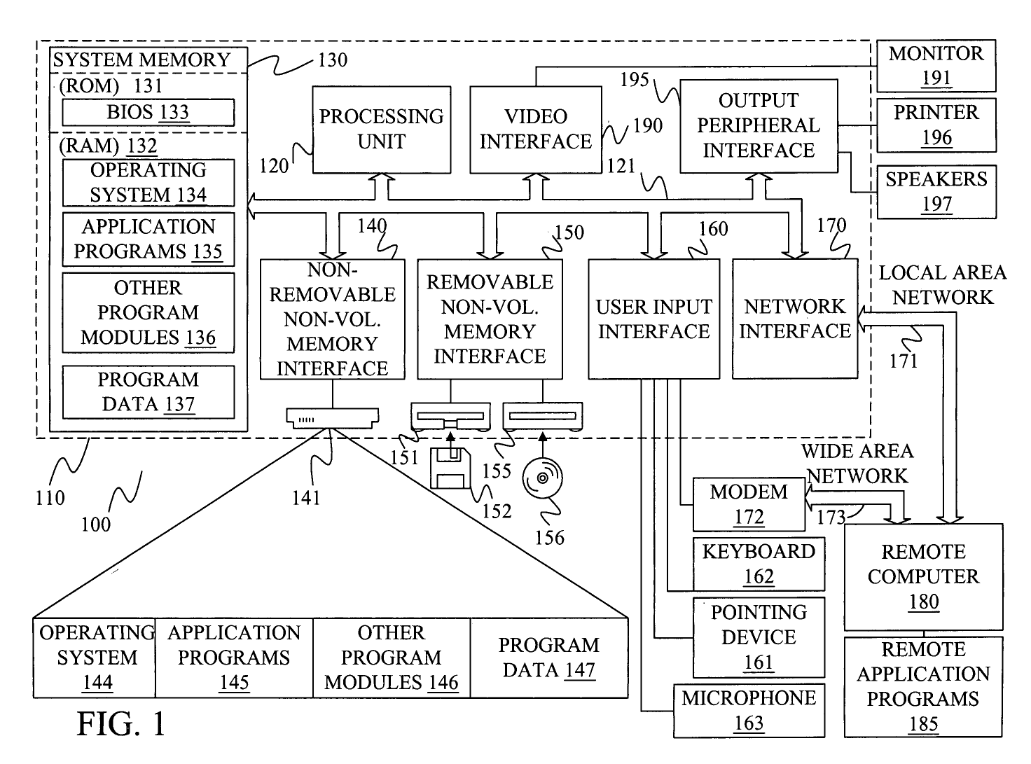

FIG. 1 illustrates an example of a suitable computing system environment 100 on which embodiments may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing some embodiments includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

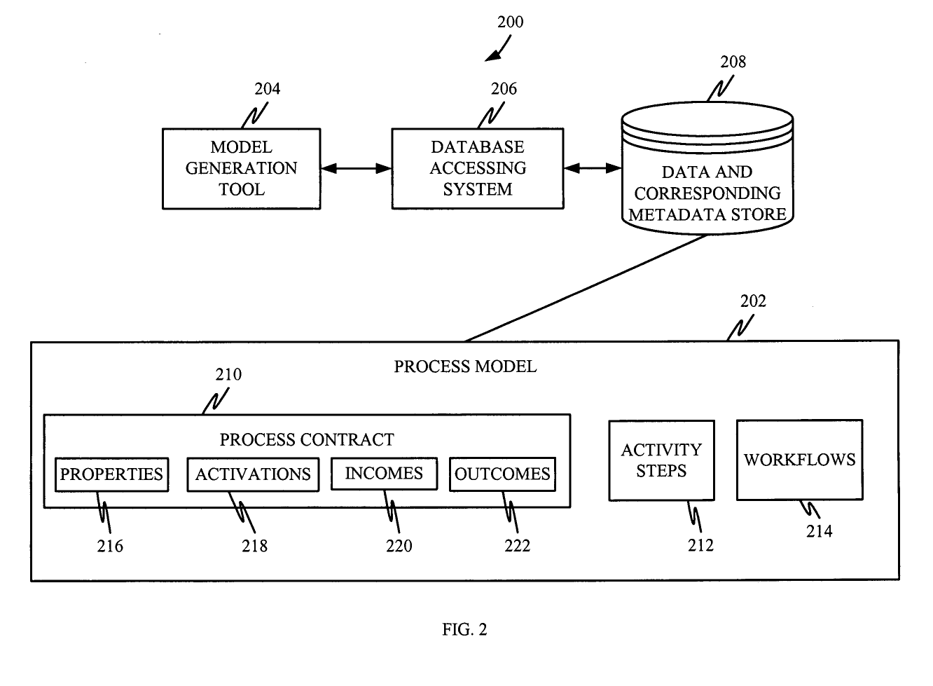

FIG. 2 shows a model generation system 200 for generating a process model 202 in accordance with one embodiment. System 200 includes model generation tool 204, database accessing system 206, and data and corresponding metadata store 208. Model 202 is illustratively stored in data store 208. In one illustrative embodiment, a user uses tool 204 to define process model 202 and store it in database 208.

Process model 202 is illustratively a declarative model (as opposed to imperative code) developed to describe processes within business software applications. The description abstractly defines a process and its relationship to other processes in a way that is independent of workflow technology implementations. Model 202 also illustratively captures data aspects of a business process and allows that data to be associated with other domain data, thus providing the ability to semantically link process with the data that is usually found in business applications.

More specifically, the process definition is similar to a type in that it can be instantiated any number of times. A process instance represents a running process. Process model 202 is an abstraction that semantically links the steps, data, and other elements necessary to achieve a business goal. It illustratively enables initiating, identifying, monitoring, coordinating, and completing the set of activities involved with obtaining the business objective.

In the embodiment shown in FIG. 2, process model 202 includes a process contract 210, a set of activity steps 212 and a set of workflows 214. The workflows 214 sequence activity steps 212 in such a way as to satisfy process contract 210.

More specifically, process contract 210 represents an interface for the process modeled by model 202. The contract 210 defines the initial and interim inputs and outputs to the process as well as the data properties for the process. Thus, items included within the process contract are properties 216, activations 218, incomes 220, and outcomes 222.

Properties 216 store the data attributes of a running process. Also, after a running process has concluded, properties 216 reflect the final process state. The set of properties 216 in contract 210 can be stored, for example, as an entity. An entity is an instance of a type having a set of properties, where the value of some set of those properties is unique for the entity within some scope. By defining properties 216 as entities, the model is highly useful, because management of the properties and querying of those properties can easily be implemented using the same technology as is used for all other application data.

Activations 218 initiate the process modeled by model 202. Activations 218 can have input parameters that specify data. The input parameters are passed to an operation in the process as a data payload income to the process. As is discussed in greater detail below, the activations provide a mechanism for selectivity, to select among various workflows and initiate a selected workflow when the process is initiated.

The activations 218 enable the process to be initiated in different ways. It also allows workflows 214 to start with different payloads, and provides the ability to select the workflow 214 that gets initiated during activation of the process. The particular mechanism used for activations is not part of the present invention, and a variety of different mechanisms can be used.

Incomes 220 are operations that provide a defined entry point into a running process. Incomes 220 may require and consume business data as an input. Zero or more incomes 220 are defined for a process modeled by model 202. Incomes 220 can represent either an external request that a process can act on or an external response that a process is waiting on. This provides the ability to call business logic or process control operations, and to provide data that a process is waiting for.

Outcomes 222 signify that a running process has concluded. They represent defined exit points from the running process, and may define and produce business data as an output. An outcome 222 can be marked as a required outcome or as an optional outcome. One or more outcomes 222 are illustratively defined for each process. Outcomes 222 allow the process to return results and to signify conclusion of the process. They also provide a mechanism for the process to return data payloads.

Process model 202 also includes the activity steps 212 which represent the units of work that can be arranged in workflows. Each activity step 212 may, in one embodiment, be an operation, along with metadata, that binds data to the input and output parameters of the calls to the operation. The activity steps can be orchestrated within workflows 214, as is described in greater detail below.

There are illustratively a number of different types of activity steps 212. Some of those include business logic calls, which provide a linkage between processes and data in process model 202. With this linkage, one can determine what processes affect what data, and vice versa. Business logic calls may illustratively use entities to create or modify data. For instance, business logic calls may be handwritten imperative code created by business application developers.

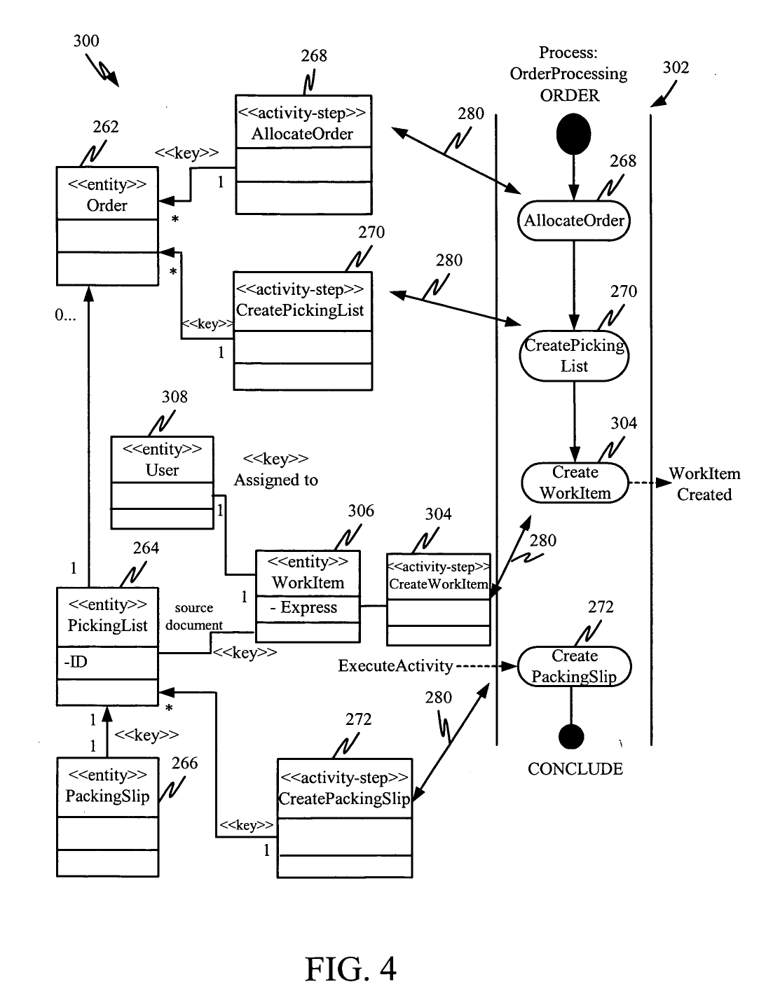

A second kind of activity step 212 is a work item call (or work item). A work item generates a request for users to perform task-oriented work. A work item task is created and illustratively assigned to a user or role for completion. Model 202 provides semantic links to related information and actions that can be performed to complete the work. When the work is completed, the workflow receives the work item results, as is also described below with respect to FIG. 4.

Another activity step 212 is a subprocess call. A subprocess is a process which is called within another process. The parent process may continue and simply receive results of the subprocess when the subprocess calls back with data to the parent process, or the parent process may block and wait for the results of the subprocess to be returned.

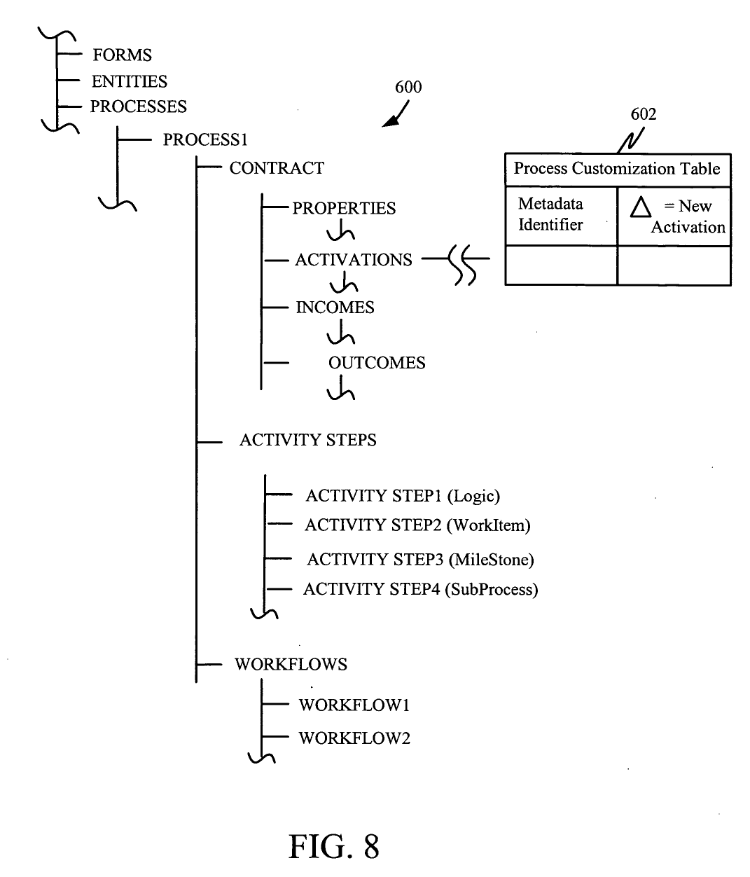

Another activity step 212 is a milestone call. A milestone call can be used to announce the status of achieved milestones. Milestones thus may be used simply for visibility as indicating the status of the process, or in blocking further execution of the process until some time or event occurs. Milestones can also be used in customizations. This is described in greater detail below with respect to FIG. 8.

The activity steps 212 provide a context for calls and bind data to operation properties and bind operation results to process properties. They also allow for calls to be re-used in the same workflow or different workflows for a given process. They also simplify the workflow design process in that workflow designers may choose to orchestrate from a set of available activity steps within a given process model 202. The activity steps are declarative, which facilitates adapting and improving the process.

The process definition in process model 202 can have one or more workflows 214 defined for it. Each workflow arranges a set of activity steps 212 for execution. A number of different approaches can be used by workflows 214 in arranging activity steps 212. For instance, the activity steps 212 can be ordered in a sequential manner for a sequential workflow, or the activity steps can be arranged based on constraints in constraint-based workflows in which rules with associated actions determine workflow execution. Of course, other workflow arrangements can be used as well.

Each workflow 214 satisfies contract 210 in the process definition in model 202. As briefly mentioned above, a plurality of different workflows 214 can be defined in any given model definition. The workflow that gets selected for execution when a process is initialized is determined by the activation 218 which is called to initialize the process. A given workflow 214 can be selectable using a number of different selection mechanisms. For instance, a workflow 214 can be selected at deployment time based on the deployed configuration of the process. The workflow 214 can also be selected based on a runtime determination using imperative code, metadata lookup or using a business rule. The workflow 214 can also be selected at runtime by making a determination with another process workflow 214. Of course, other selection mechanisms can be used in the activations 218 to select a workflow 214 as well.

Because the process contract 210 is defined in an abstract way relative to the workflow 214, it does not change with different workflows 214. Therefore, the actual interface and the implementation of a process are separated. This allows workflows 214 that share contracts 210 to be interchanged. It also supports the ability to compose processes. For example, the development approach to composing a process separates the process designers and implementers into different roles, and often different individuals. By separating the interface and workflows of the process, they better fit the development approach to design. This type of abstract process definition may also be useful for documentation and library searches.

Workflows 214 enable process automation. They define the flows and constraints to determine the course of action taken by the process. They effectively connect applications and people to collaboratively perform work. They also allow for different implementations of a single process and the particular workflow 214 that gets run is chosen using a selector mechanism, as discussed above.

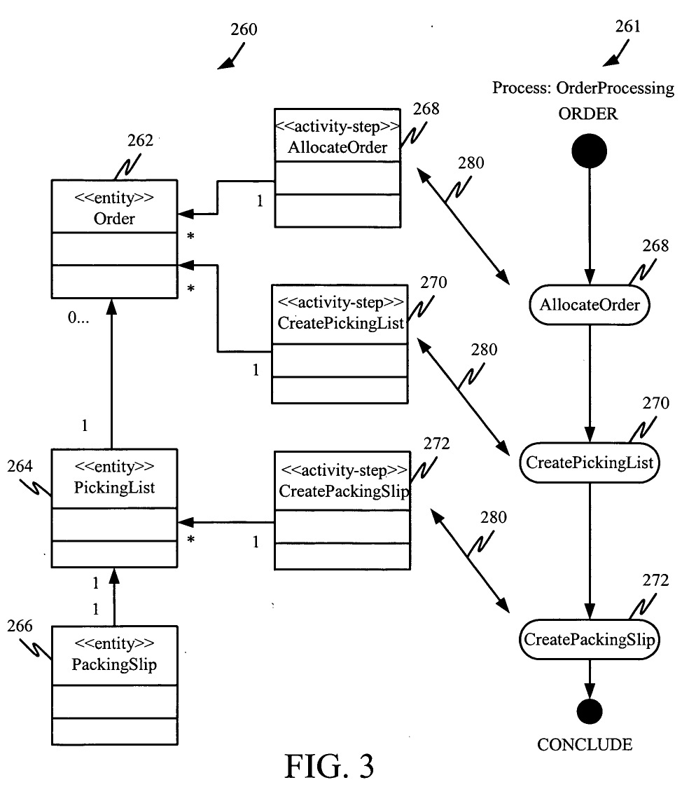

FIG. 3 is a diagram better illustrating how data, activity and process are semantically linked by model 202 in accordance with one embodiment. FIG. 3 illustrates a diagram of a model for an order processing process. In the process, an order is received and inventory is allocated to that order. A picking list is then generated such that employees in a warehouse can pick inventory items from shelves in order to fill the order. Once all of the items have been picked, they are packed for shipment and a packing slip is created.

FIG. 3 shows that one representation of data, activity, and process takes two different UML diagrams, diagrams 260 and 261. The first UML diagram 260 is a class diagram that shows an Order entity 262, a PickingList entity 264, a PackingSlip entity 266. Diagram 260 also includes an AllocateOrder activity 268, a CreatePackingList activity 270 and a CreatePackingSlip activity 272. The relationship between data (entity) and activities is captured by class diagram 260. It can be seen that Order entity 262 has zero or more PickingList and entities 264, and a given PickingList 264 has one PackingSlip 266. All of the activities 268, 270 and 272 are associated with an entity. With a simple user interface, where a list of data is displayed, a user can select an entity and be presented with a context menu which allows them to perform activities associated with the entity. Thus, given an entity, the user can easily discover which activities can operate on that entity.

The relationship between activities and process is captured by UML activity diagram 261. The activity diagram 261 illustrates an OrderProcessing process in which the AllocateOrder activity 268, the CreatePackingList activity 270 and the CreatePackingSlip activity 272 are sequenced into a workflow 214. Thus, the activities provide the linkage between the diagrams 260 and 261. This linkage is represented by arrows 280 and can be used to traverse between the two model diagrams 260 and 261.

The process represented by diagram 261 begins when a new order is entered. The process then executes the AllocateOrder activity 268, the PickingList activity 270, and a CreatePackingSlip activity 272 in sequence, without any wait points. While the diagram displayed is quite simple, it will be appreciated that, in a real application, the activity diagram may be more complex. For example, it may have looping constructs to handle a case where an order is only partially allocated. In such a case, a business may wish to create one picking list right away for items in stock, and loop around to create another picking list when the remaining items come into stock, but the diagram shown in FIG. 3 illustrates the basic points.

FIG. 3 illustrates that each activity 268-272 is associated with the entity 262-264 that it operates on. For instance, given an Order entity 262 as an input, the AllocateOrder activity 268 contains the business logic to allocate inventory for items on the order. Given an Order entity 262 as an input, the CreatePickingList activity 270 contains the logic to create a new picking list entity 264 from the specified Order 262. Basically, any items which are successfully allocated in the previous step are moved on to the new picking list. The PickingList 264 instructs the inventory staff to pick the allocated items off the shelf and put them in a box for shipment. Finally, the CreatePackingSlip activity 272 takes a PickingList entity 264 as an input, and creates a PackingSlip entity 266 which is then attached to the box for shipment.

Relating diagrams 260 and 261 to the model shown in FIG. 2, activities 268-272 corresponds to activity steps 212 in model 202 shown in FIG. 2. The specific ordering of activity steps shown in diagram 261 in FIG. 3 corresponds to one workflow 214 shown in model 202 in FIG. 2. The activation 218 in FIG. 2 corresponds to the order received in FIG. 3, and to the outcome 222 corresponds to the state in which the process is concluded. Of course, an entity which indicates that the process is running or has concluded may also be a visible property 216 shown in FIG. 2 as well. The order itself may be provided to the process as an income, or as an activation, or the order may be represented by the process itself.

FIG. 4 illustrates a UML class diagram 300 and a UML activity diagram 302 for a slightly more complex process. A number of the items are similar to those shown in FIG. 3 and are similarly numbered. The diagram shown in FIG. 4 introduces a work item into class diagram 300 and process activity diagram 302. The work item introduces into the previously automated process (that shown in FIG. 3) a wait point for a human action. In other words, the process dispatches a “to do” notification to a user and waits for the user to respond. Once the user responds, the automated process resumes.

The process shown in FIG. 3 is sufficient if all processing is supposed to run automatically. However, in a true application, the CreatePackingSlip activity 272 would likely not run automatically after the CreatePackingList 270. In a conventional warehouse, the picking list would first print. Then, the warehouse staff would pick up the list from the printer and walk through the warehouse picking the goods. When the boxing is complete, the staff would normally manually execute the CreatePackingSlip activity 272, which signals that the box is ready to ship.

In FIG. 4, activity diagram 302 shows that, again, once an order is created, inventory is allocated and the picking list is created automatically by activities 268 and 270. However, once the picking list is created, the activity labeled CreateWorkItem 304 generates a WorkItem entity 306 (which represents the “to do”) and assigns it to user 308. The process then stops automatic execution by emitting a WorkItem Created status message illustrated in diagram 302.

Once the status message is emitted, the process pauses until a message is received from the user 308 to execute the CreatePackingSlip activity 272, at which point the process resumes.

Class diagram 300 shows that the human-based wait point has been introduced to generate the WorkItem 306 (i.e., the “to do”) and assign it to user 308. The WorkItem 306 is illustratively associated to one or more activities. In the embodiment shown in FIG. 4, the User 308 has only one choice, to create the PackingSlip 272. However, other common scenarios could involve a choice such as approval or denial of a certain request, etc. In such a case, the WorkItem 306 holds multiple references to activities, one for each choice. In one illustrative practical application in which the model illustrated in FIG. 4 is implemented, at runtime a query service might illustratively query the system for all WorkItems 206 assigned to a given User. The query service would illustratively use the model shown in FIG. 4 to traverse the entities and activities to aggregate data from multiple entities and activities into the query results. The query results would illustratively list all of the workflow tasks including WorkItem 306 (assigned to the user). Such items can be displayed to the user and the user can take whatever desired action is necessary for the process to continue. For instance, the user may select (from a user interface display) a “Create Packing Slip” option which re-starts process execution, and the cycle is completed.

There are multiple different ways in which the model 202 (represented by the diagrams in FIGS. 3 and 4) can be generated, and the specific way in which tool 204 is used by the user to generate the model is not important for purposes of this discussion. However, two ways will be described for the sake of example.

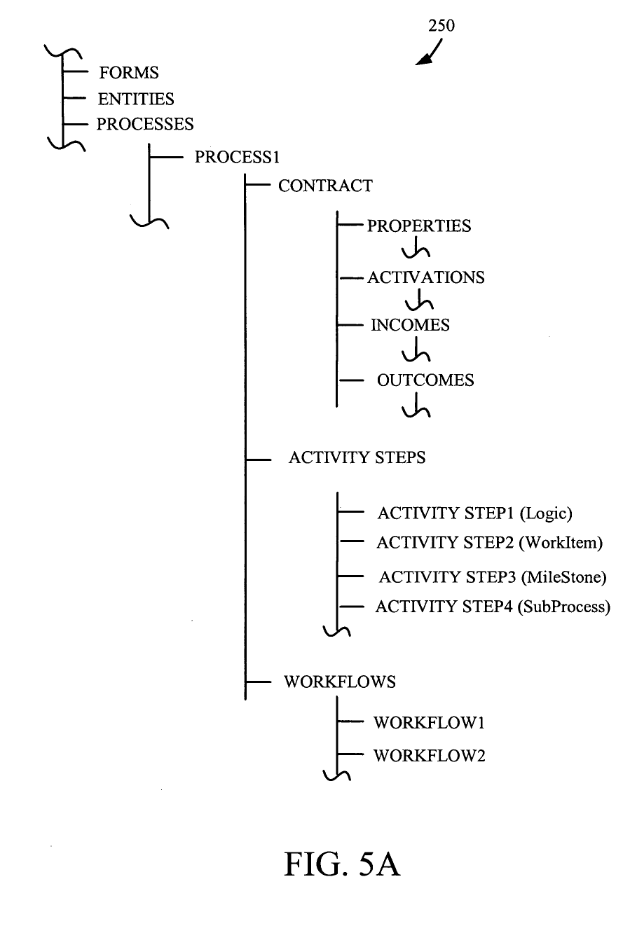

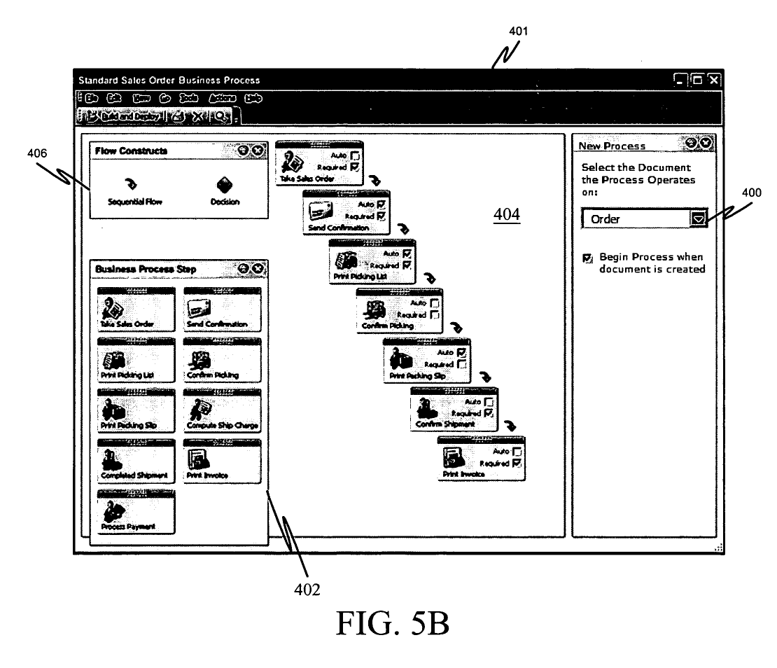

FIG. 5A shows one exemplary metadata structure 250 which defines a process. The process “PROCESS1” includes a contract, activity steps and workflows. The metadata structure 250 shows that the contract includes properties, activations, incomes and outcomes. Structure 250 also shows that the activity steps include logic, a work item, a milestone and a subprocess.

The user will illustratively generate model 202 simply by modifying the tree structure 250 in metadata (creating, deleting and moving nodes in tree structure 250) to define different processes. The user can do this by adding or re-arranging any of the items in the process, including any items in the contract, activity steps or workflows.

FIG. 5B shows one exemplary embodiment of a tooling approach in which a process model can be generated. In the embodiment shown in FIG. 5B, it is assumed that class diagram has already been generated which specifies entities and associated activities, for the process being designed. To continue designing the process, the author first selects an entity of focus and enters into that entity into field 400 on user interface display 401. In the embodiment shown in FIG. 5B, the entity chosen for focus is an Order entity. This effectively gives the designer a starting point on the class diagram to operate from.

Given the entity for context, the tool displays a palate 402 of process steps or activity steps that can operate on that particular entity. The designer can easily arrange activities which operate on the entity by dragging them out onto the designer surface 404 of display 401 and sequencing them into a process schedule using one of the selectable flow constructs 406. It will be noted in FIG. 5B that additional activities, other than those shown in FIGS. 3 and 4 are included, by way of example.

FIG. 5B shows that the deep semantic knowledge contained in the model 202 (represented by diagrams 300 and 302 in FIG. 3) enables the process to be designed without any imperative code. In order to generate the imperative code, the focus entity of the process is simply passed to the selected activity and imperative code is generated, if needed.

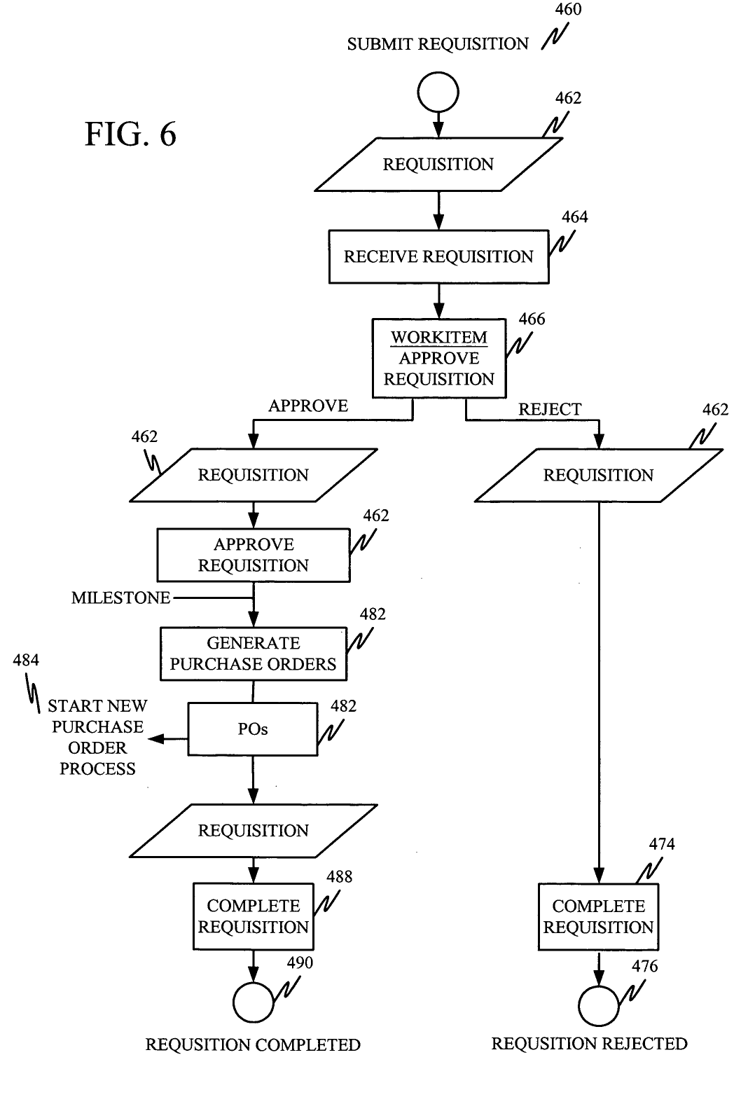

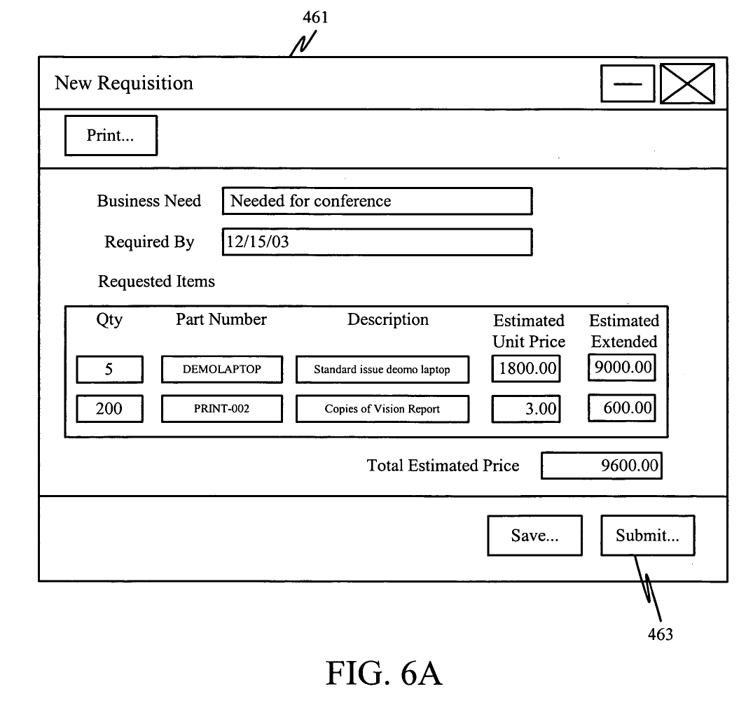

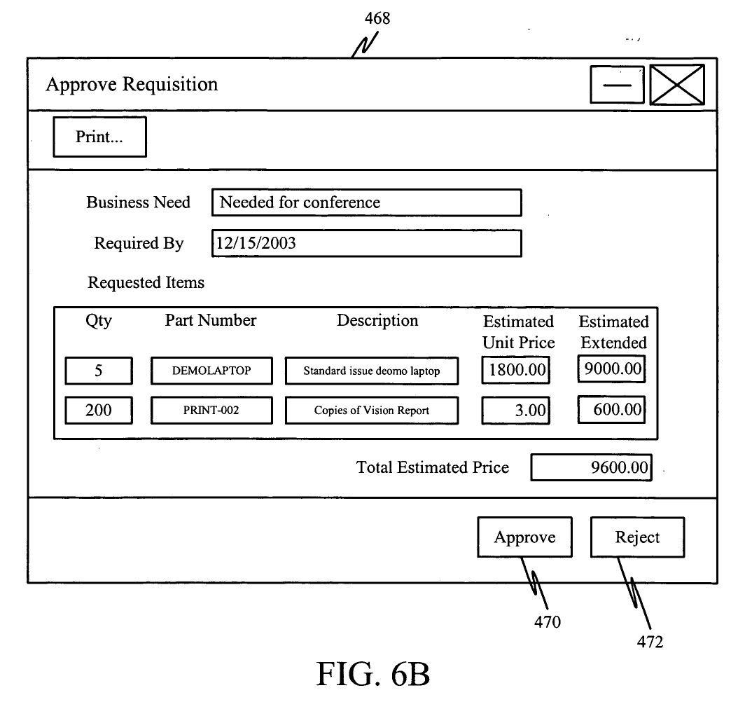

FIG. 6 illustrates another, slightly more complex process for the sake of example. In FIG. 6, the process is one which is initiated by a requisition, which is either approved or rejected. If it is approved, then a purchase order is generated and the requisition is completed. If it is rejected, the requisition is completed as rejected. It will of course be understood that FIG. 6 illustrates only one workflow for the modeled process. There may well be more than one workflow in the modeled process, and the runtime subsystem selects a workflow based upon one of a variety of different criteria, such as those described above with respect to FIG. 2. For instance, the determination can be made based on metadata, a configuration value, a business logic rule, etc.

In any case, FIG. 6 shows that the process has, as an activation, the Submit Requisition activation 460 and the requisition 462, itself, is illustratively provided with activation 460, or as a separate income to the process.

FIG. 6A illustrates an exemplary user interface display 461 which shows how a user may illustratively enter a new Requisition 462 to start the process shown in FIG. 6. The example shown in FIG. 6A has a variety of descriptive information regarding the Requisition, which is first filled in by the user. The user then actuates the Submit button 463 which passes the Requisition, as an activation, to the process, to start the process.

Next, the Receive Requisition activity 464 is executed by the runtime subsystem. The Receive Requisition activity 464 may illustratively validate the Requisition using business logic and set a requisition status value to “received”. The Receive Requisition activity 464 may also illustratively save, or persist, the Requisition itself.

Once the Receive Requisition activity 464 has completed, Requisition 462 is passed to WorkItem 466. WorkItem 466 requires human intervention, in this case, to either approve or reject the requisition.

FIG. 6B shows another exemplary user interface display 468 which can be used by a user to perform the WorkItem of either approving or rejecting the Requisition 462. Display 468 in FIG. 6B shows that the Requisition 462 can be displayed to the user who has authorization to perform the WorkItem 466, and the user can either actuate the Approve button 470 or the Reject button 472.

If the user rejects the Requisition 462, the Requisition 462 is passed to the Reject Requisition activity step 474 shown in FIG. 6. The Reject Requisitions activity step 474 illustratively sets the requisition status indicator to rejected and persists or saves the Requisition 462. The process then generates the requisition rejected outcome 476.

If, however, at WorkItem 466, the user approves the requisition by actuating the Approve Requisition button 470 shown in FIG. 6B, the Requisition 462 is provided to Approve Requisition activity step 478. The Approve Requisition activity step 478 illustratively sets the requisition status indicator to approved and persists the requisition.

The process then generates milestone 480. In the illustrated embodiment, milestone 480 is simply a property representing the status of the running process. Of course, the milestone could be any other desired milestone activity step.

Processing then continues by executing the Generate Purchase Orders activity step 482. In activity step 482, the process generates a plurality of Purchase Orders 484 to fill the Requisition 462. For instance, the exemplary Requisition being discussed is requesting five laptop computers and two hundred copies of a report. Therefore, Purchase Orders for these items are generated by Generate Purchase Orders activity step 482. The process shown in FIG. 6 also shows, at this point, that the process provides an outcome 484, which is a Start New Purchase Order process outcome that signifies that a new purchase order process should be activated. The new purchase order process illustratively identifies a source to fill the Purchase Orders 482 which were generated by the process shown in FIG. 6 and illustratively automatically assigns the purchase orders to a vendor, along with a contract price, and sends the purchase order to the vendor. Of course, the new purchase order process started by outcome 484 could be other processes as well, and the one described is provided for exemplary purposes only. It should also be noted that the new purchase order subprocess may, itself, start additional processes such as a process which obtains quotes from various vendors, prior to sending a purchase order to a vendor, or a process which simply selects a vendor and obtains a quote from the vendor prior to sending the purchase order. Of course, a wide variety of other processes could be initiated as well.

In any case, once the New Purchase Order process has been activated, the process shown in FIG. 6 executes the Complete Requisition step 488. Activity step 488 illustratively sets the requisition status indicator to completed and then provides the Requisition Completed outcome 490.

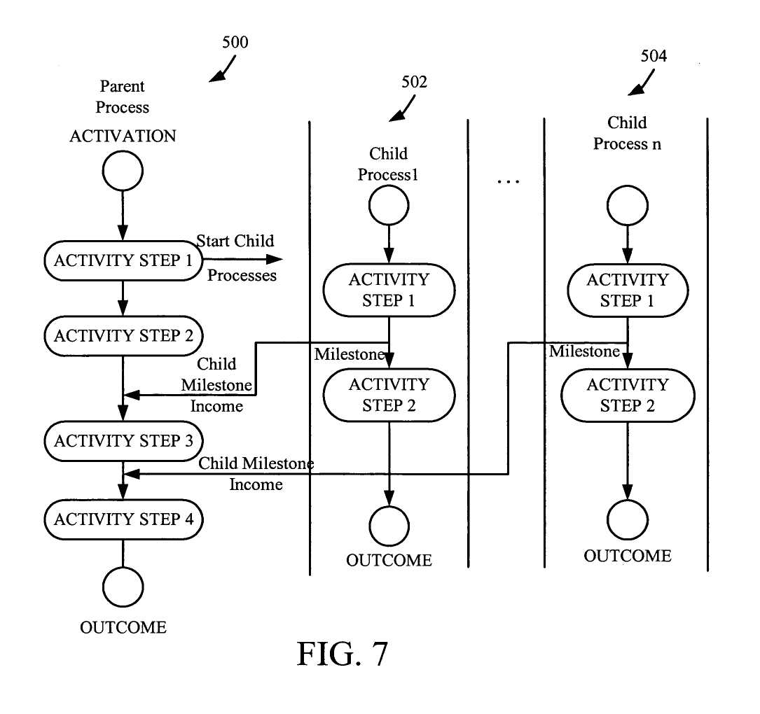

FIG. 7 illustrates a model in accordance with one illustrative embodiment of the present invention which can be used to capture process patterns. For instance, a process can have discoverable structural or behavioral patterns that can be captured in metadata and applied multiple times when building an application. The pattern illustratively has a semantic linkage to instances where it has been applied, so that, when the base pattern has changed, it can easily be determined where else in the application that the pattern needs to be updated, either automatically or manually. In the case of manual update, the system simply throws a flag or an error indicating that a certain portion of the application is based on a pattern which has been changed.

FIG. 7 illustrates one exemplary pattern in which a parent process 500 interacts with a plurality of processes shown as child process 1, 502, and child process N, 504. The parent process 500 has four activity steps. Activity step 1 starts one or more of the child processes 502 and 504. Parent process 500 also pauses after activity step 2 until it receives a milestone, as an income, from child process 502. Parent process 500 pauses after activity step 3 until it receives a milestone, as an income, from child process 504. The milestones represent the current status of the running child processes 502 and 504. This property is set by calling a milestone activity step operation. Whenever the milestones are reached by the child processes 502 and 504, parent process 500 receives an income that notifies the parent of the milestone change. The parent process 500 can then respond as appropriate, including making a determination of whether to execute a milestone activity step as part of its running process, whether to continue running other activity steps, etc.

Of course, the pattern shown in FIG. 7 is provided merely as one simple example of how a process pattern involving a parent process and child processes might be applied. The present invention is not limited to that example, and the process patterns captured in metadata can vary widely, and can be applied in substantially any desired way.

FIG. 8 illustrates one embodiment in which a process is customized, or modified. FIG. 8 shows a metadata structure 600 similar to that shown in FIG. 5A. However, FIG. 8 also shows a process customization table 602 which contains customizations to the process defined in metadata structure 600. The process shown by structure 600 represents a base process created by one party. However, that may be customized by zero or more additional parties after the base workflow has been created and delivered to market. For instance, customizations may be made for a particular customer or even for a particular department within a customer, once the process application has been deployed.

The changes to the base process are referred to as deltas. The deltas are stored separately from the base process 600, in table 602, and are only applied to the base process 600 when the application running the process is deployed. Some examples of customizations to a workflow include adding activity steps, removing or replacing activity steps, changing data and control flow, etc.

The process customization table 602 shown in FIG. 8 illustrates that changes to the activations in process 600 are made as customizations. The metadata identifier in table 602 identifies the activations metadata in structure 600 and the delta entry identifies a new or different activation which is used to activate the process, once the process has been customized.

Storing the customizations separately from the base process provides a number of advantages. For instance, the customer may only want to apply customizations in a certain context, such as when the process is run in a given department within the customer. Similarly, the customer may be having problems with the customized process and may simply want to turn off the customizations. Reverting to the base process becomes very simple, if the customizations are stored separately and only applied when desired. Similarly, updates to the base process can easily be made without worrying about customizations. When the base process 600 is updated, customizations in table 602 can then be applied to the updated base process 600. The customizations are simply not intertwined with the base process, making updates much more simple and quick.

In addition, it may occur that a user wishes to merge two different sets of customizations. This can be easily accomplished simply by applying both sets of customizations to the base process 600. There may be a need for a conflict resolution component in the event that two customizations are drawn to a same part of the base process. However, multiple sets of customizations can be applied to the base process in relatively easy fashion.

In addition, the user can declaratively express how a delta gets applied. For instance, the user may indicate, declaratively, that the customizations are to be applied before a given activity step, milestone, or other item in the base process, and after a different milestone, etc. This provides a great deal of versatility in applying customizations.

It can be seen that the declarative model of the present invention thus describes processes within business software applications in such a way that an abstract model is developed describing processes and their relation to other processes, independent of workflow implementation. The model captures data aspects of a business process and allows this data to be associated with other domain data, providing the ability to link process and data usually found in business applications. The modeling includes a set of process and workflow abstractions which captures the attributes of a process, such as how the process is started, what comes in and out of the process, visible data processes, etc., and the process can be supported by zero or more actual implementations of workflow, so the workflow acts as one implementation of an abstract process represented by the model.

A selectivity mechanism is also provided such that when it comes time to run a process, a selection determination is made as to which workflow to use. Of course, this selection can be made at configuration time as well as at runtime. Because there is a separation between the abstract representation of the process and the technology-dependent implementation of workflow, different implementations of the process can be swapped out (i.e., different workflows) either at implementation of the process or at runtime.

In addition, the process remains as an entity, even after it has completed execution. Traditionally, workflow is viewed as something which is currently running, and at times, status can be obtained from the workflow. However, if the workflow has completed execution, there is conventionally no representation of the workflow that remains. However, with one embodiment of the present invention, the process is represented by an entity which can simply be queried for its status and other observable properties of the process entity. Also, because it is an entity, it has associative relationships to the data that it changed. Therefore, a user can easily determine what data is affected by a given process, what process created the data, etc. The present system also provides the ability to easily capture and apply process patterns, and to make customizations to a base process.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A model of a computer-automated process, comprising:
a process contract defining an interface to the process, independently of an implementation of the process;
a set of activity steps, at least some of the activity steps being performed in implementing the process; and
a set of workflow implementations that conform to the process contract and each comprise an arrangement of the activity steps.

2. The model of claim 1 wherein the process contract comprises:
a set of visible properties indicative of a state of the process.

3. The model of claim 2 wherein the process contract comprises:
a set of activations that can be called to initiate the process.

4. The model of claim 3 wherein each activation is indicative of which of the set of workflow implementations to initiate in order to initiate the process.

5. The model of claim 2 wherein the process contract comprises:
a set of incomes indicative of possible entry points into the process.

6. The model of claim 5 at least some of the incomes include data for input to the process.

7. The model of claim 2 wherein the process contract comprises:
a set of outcomes indicative of possible exit points from the process.

8. The model of claim 7 wherein at least one of the outcomes includes a final outcome indicative of a result of the process.

9. The model of claim 1 wherein each of the set of activity steps includes metadata binding the activity step to data used in the process.

10. The model of claim 1 wherein the set of activity steps comprise:
business logic that operates on data.

11. The model of claim 1 wherein the set of activity steps comprise:
a work item that generates a request for a user-performed task in the process.

12. The model of claim 1 wherein the set of activity steps comprise:
a milestone that is indicative of a current status of a running process.

13. The model of claim 1 wherein the activity steps comprise:
a subprocess initiated by the process.

14. The model of claim 1 wherein the process contract, the set of activity steps and the set of workflow implementations are defined in metadata, and wherein a customized process is represented by customizations of the process separately stored in a customization data store as differences between the process and the customized process, the customizations being applied to the process to obtain the customized process.

15. A model of a computer-automated process comprising:
a predefined process pattern that includes a plurality of processes, each process comprising:
a process contract defining an interface to the process, independently of an implementation of the process;
a set of activity steps, at least some of the activity steps being performed in implementing the process; and
a workflow implementation that conforms to the process contract and comprises a sequence of the activity steps.

16. A method of performing a computer-implemented process, comprising:
providing a process model comprising:
a process contract defining an interface to the process, independently of an implementation of the process, the interface including an activation which, when called, initiates the process;
a set of activity steps, at least some of the activity steps being performed in implementing the process; and
a plurality of workflow implementations that conform to the process contract, each workflow implementation comprising a sequence of the activity steps;
calling the activation;
identifying which workflow implementation to initiate based on the activation; and
initiating the identified workflow implementation.

17. The method of claim 16 and further comprising:
executing one of the set of activity steps in the identified workflow implementation to generate a work item identifying a task for human completion.

18. The method of claim 16 and further comprising:
generating milestones at different points in the identified workflow implementation.

19. The method of claim 16 and further comprising:
executing customized activity steps at a predefined point in the identified workflow implementation.
